(19) United States
(12) Patent Application Publication
(10) Pub. No.: US 2014/0236779 A1
(43) Pub. Date: Aug. 21, 2014

(54) SYSTEM AND METHOD FOR PRODUCT IDENTIFICATION AND CATALOGING

(71) Applicant: Plant Together, Inc., Great Falls, VA (US)

(72) Inventors: Edward Barrientos, Great Falls, VA (US); Daniel Sunshine, Alexandria, VA (US)

(73) Assignee: PLANT TOGETHER, INC., Great Falls, VA (US)

(21) Appl. No.: 14/179,014

(22) Filed: Feb. 12, 2014

Related U.S. Application Data
(62) Division of application No. 12/768,465, filed on Apr. 27, 2010, now abandoned.

(51) Int. Cl. G06Q 50/00; G06Q 10/08

(52) U.S. Cl. CPC G06Q 50/01; G06Q 10/087
USPC 705/28

(57) ABSTRACT

In some embodiments, a method includes accessing a provider interface. The provider interface is associated with a provider having at least one asset for purchase. The asset can be, for example, a plant-related product, a livestock-related product and/or the like. Data associated with the asset and/or the provider is input into the provider interface, which is then configured to display a unique code generated based on the data input. The asset is associated with the unique code, for example, by providing the consumer with the unique code at the time of purchase. In response to a consumer request, information associated with the asset is provided. More specifically, the information associated with the asset is retrieved from a database accessible via the provider interface.

### CROSS REFERENCE TO RELATED APPLICATION

This application is a divisional of and claims priority to U.S. patent application Ser. No. 12/768,465, filed Apr. 27, 2010, and entitled “SYSTEM AND METHOD FOR PRODUCT IDENTIFICATION AND CATALOGING,” which is incorporated herein by reference in its entirety.

### BACKGROUND

The invention relates generally to a system and method for product identification and cataloging. More particularly, this invention relates to a system and method for plant-related product identification and cataloging.

Many known products that are sold in the current retail market have very little to no post-purchase support. For example, many of these products do not include instruction manuals or other guides that provide information on how to care for those particular products throughout their product-life. Some known products are associated with websites, webpages, or other online programs with limited functionality that provide purchasers (i.e., consumers) with general information on caring for those particular products. However, some products, such as plants or other plant-related products, require more than just the general information provided by those websites. More specifically, plant-related products require considerable post-purchase care and, as a result, many of the purchasers of such plant-related products need more post-purchase support than the average product purchaser.

Some large national retail stores selling plant-related products maintain websites or other online programs that consumers can access to obtain information related to that plant-related product purchased at that store. Some retail stores have websites that allow consumers to set up an account where they can store plant tags representative of the different types of plants purchased from the retail store. The plant information associated with the plant tags, however, is static so the consumer cannot change or personalize the plant information to suit his or her specific needs. Some such websites allow consumers to comment on the plant tags associated with other consumers' accounts, but this is the only interaction between consumers that is available on the websites. As such, these websites have limited functionality and limited social networking capability.

Moreover, such websites are only intended to be used by the end-user or final purchaser of the product. More specifically, these websites accommodate only one type of consumer and are therefore not suitable for use by any intermediate retailers (e.g., local nurseries, landscapers, etc.). Thus, the consumer using the website is only exposed to information provided by other like consumers and the larger retail store maintaining the website.

Most plant-related products are purchased at small, local nurseries that have limited funds and, unlike the aforementioned larger national retailers, rely on old, out-dated technology to run the business. As a result, these nurseries can have difficulty tracking their current inventory and past purchases made by consumers. More importantly, these nurseries can have difficulty marketing themselves and keeping in contact with past purchasers—both of which can be imperative to grow a small business. Most small, local nurseries have a short lifespan due to these limitations.

Thus, a need exists for an improved, low-cost system or method of tracking plant-related inventory and reaching out to and keeping in contact with current or potential consumers. A need also exists for an improved system or method of providing purchasers of plant-related products with more specific and helpful post-purchase support through the use of a social network having increased functionality.

### SUMMARY

In some embodiments, a method includes accessing a provider interface. The provider interface is associated with a provider having at least one asset for purchase. The asset can be, for example, a plant-related product, a livestock-related product and/or the like. Data associated with the asset and/or the provider is input into the provider interface, which is then configured to display a unique code generated based on the data input. The asset is associated with the unique code, for example, by providing the consumer with the unique code at the time of purchase. In response to a consumer request, information associated with the asset is provided. More specifically, the information associated with the asset is retrieved from a database accessible via the provider interface.

### BRIEF DESCRIPTION OF THE DRAWINGS

FIG. 1 is a schematic illustration of an online platform having a provider module and a consumer module, according to an embodiment.

FIG. 2 is a schematic illustration of a provider module according to an embodiment.

FIG. 3 is a schematic illustration of a consumer module according to an embodiment.

FIG. 4 is a plane view of a code printed on a label according to an embodiment.

FIG. 5 is a perspective view of a marker with a code coupled to an asset according to an embodiment.

FIG. 6 is an example of a graphical user interface according to an embodiment.

FIG. 7 is a schematic illustration of a consumer interface according to an embodiment.

FIG. 8 is a schematic illustration of a provider interface according to an embodiment.

FIG. 9 is an example of a graphical user interface including a plant card according to an embodiment.

FIG. 10 is a flow chart of a method according to an embodiment.

FIG. 11 is a flow chart of a method according to an embodiment.

FIG. 12 is a flow chart of a method according to an embodiment.

FIG. 13 is a flow chart of a method according to an embodiment.

FIG. 14 is a flow chart of a method according to an embodiment.

### DETAILED DESCRIPTION

Systems and methods for product identification and cataloging are described herein. In some embodiments, a method includes accessing a provider interface. The provider interface is associated with a provider having at least one asset for purchase. The asset can be, for example, a plant-related product, a livestock-related product and/or the like. Data associated with the asset is input into the provider interface, which is then configured to display a unique code generated based on the data input. The asset is associated with the unique code, for example, by providing the consumer with the unique code at the time of purchase. In response to a consumer request, information associated with the asset is provided. More specifically, the information associated with the asset is retrieved from a database accessible via the provider interface.

In some embodiments, a method includes accessing an interface associated with a provider having at least one asset for purchase. The asset can be, for example, a plant-related product, a livestock-related product and/or the like. Data associated with the asset is input into the interface, which is configured to display a unique identifier generated based on the data input. The unique identifier can be, for example, a numeric code, an alphanumeric code, or a name of the asset. The unique identifier corresponds to the asset or a genus of assets associated with the asset. A consumer is provided with the unique identifier. And, in response to a request from the consumer, information associated with the asset is provided. The information associated with the asset is retrieved from a database accessible via the interface.

In some embodiments, a method includes inputting data associated with an asset for purchase into a provider account module of a website. The website is associated with a provider, such as, for example, a landscaper, a nursery, a garden center, a farm or a store. A code, which is generated based on the data and corresponds to the asset or a genus of assets associated with the asset, is received. A purchaser account, which includes the code, is established for a purchaser of the asset. The purchaser account is configured to be accessed by the purchaser via a purchaser account module of the website. Additionally, the purchaser account is configured to provide the purchaser with information associated with the asset. In some embodiments, the purchaser account can be configured to provide the purchaser access to a plant-related social network, which operates to virtually connect the purchaser with at least one of a plurality of providers including the provider or a plurality of other purchasers.

In other embodiments, a method includes identifying, in a provider account module, a plurality of assets associated with a consumer inventory. The plurality of assets can include, for example, an asset which is a plant-related product. The provider account module is associated with a provider, such as a landscaper, of at least a portion of the consumer inventory. A consumer account, which is based on the plurality of assets, is established for a consumer. The consumer account is configured to be accessed by the consumer via a network. Additionally, the consumer account is configured to provide data associated with at least one of the assets from the plurality of assets. Such data is retrieved from a database based on the identification of the plurality of assets. In some embodiments, the method can further include updating the consumer inventory to include additional assets such that each of the additional assets are included in the plurality of assets.

In yet other embodiments, a method includes designing a landscape, which includes a plurality of assets, for a consumer. Data associated with the plurality of assets is input into a provider account module and a unique code is then generated for each asset from the plurality of assets based on the input data. The input data can be, for example, a landscape design, a location of an asset from the plurality of assets in the landscape design, a total amount of assets in the plurality of assets, and/or the like. The consumer is provided with the unique codes that were generated for each asset from the plurality of assets and is provided access to a consumer account based on the unique codes. The consumer account is configured to provide the consumer with information related to the landscape design and/or the plurality of assets. In some embodiments, the consumer account is established by the consumer using the unique codes.

In some embodiments, a system includes an interface accessible by a consumer having a unique identifier, which is associated with an asset from a provider. The asset can be, for example, a plant-related product, and the provider can be, for example, a plant nursery. The interface, which is accessible to the consumer based on the unique identifier, is configured to provide information associated with the asset to the consumer. An asset-related social network is accessible via the interface. The asset-related social network is operative to virtually connect the consumer with at least one of a plurality of providers, which includes the provider, and/or a plurality of other consumers. In some embodiments, the asset-related social network can provide the consumer, via the interface, access to consumer-created data including at least one of a Webpage, a blog, a contest, a calendar, a third-party application, a message board, a forum, and/or the like.

In other embodiments, a system includes an interface associated with a provider having at least one asset for purchase. The asset for purchase is associated with a unique identifier, which can be, for example, a numeric code, an alphanumeric code, a name of the asset and/or the like. A database containing information associated with the asset is accessible via the interface such that the information associated with the asset is retrieved from the database via the interface. An asset-related social network is also accessible via the interface. The asset-related social network is operative to virtually connect the provider with at least one of a plurality of other providers or a plurality of consumers. In some embodiments, the asset-related social network can provide the provider, via the interface, access to consumer-created data including at least one of a Webpage, a blog, a contest, a calendar, a third-party application, a message board, a forum and/or the like.

The terms “asset” and “product” are used interchangeably herein and are intended to have the same meaning unless indicated otherwise.

The term “plant-related” as used herein can refer to, but is not limited to, any living organism or thing that is associated with a plant. For example, as used herein, a plant-related product can include any type of plant, tree, seed, fruit, flower, vegetable and/or any by-product resulting from plant life. A plant-related product can also include any product related to a plant nursery or involved in gardening, landscaping and/or farming industries. Such a product can be, for example, any type of fertilizer(s), gardening tool(s), soil(s), watering system(s) and/or component(s), container(s) for housing a plant, and/or container(s) for storing other plant-related items. Further, a plant-related product can include any type of educational material (e.g., a book or video) designed to inform a person of a plant, an aforementioned plant-related product (e.g., a tree, seed, fruit, etc.), a plant nursery, gardening, landscaping, farming, and/or the like. Such plant-related products can also be referred to as “green assets”.

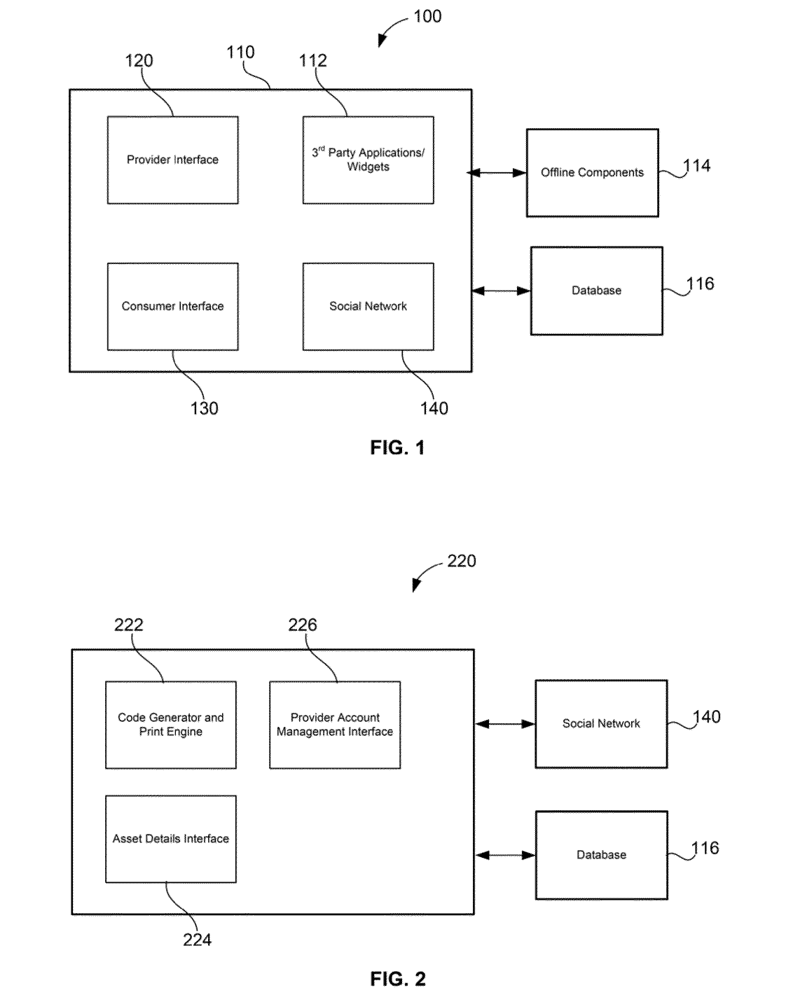

FIG. 1 is a schematic illustration of a system 100 for providing users (e.g., consumer or providers) with information related to assets. The system 100 includes a platform 110 configured to facilitate execution of a provider interface 120, a consumer interface 130, a social network 140, and third-party applications and/or widgets 112 (collectively referred to as “components”). The platform 110 can be any suitable computing platform, such as, for example, a hardware architecture or a software framework. The platform 110 can be configured to operate on a network over an intranet or the Internet. As such, the platform 110 can be referred to as an “online platform” and its components can collectively be referred to as “online components”. In some embodiments, however, the platform 110 and/or one or more of its components can operate offline.

The online platform 110 is configured to communicate with a database 116 and offline components 114 (e.g., one or more sensors). Thus, each of the online components are configured to communicate with the database 116 and/or the offline components 114. In some embodiments, however, one or more of the online components are not configured to communicate with the database 116 and/or the offline components 114. The database 116 can be any suitable database that stores information (i.e., data). The offline components 114 can be any hardware or software that does not continuously run on the online platform 110. As discussed in more detail herein, the offline components 114 can include one or more codes that are generated and associated with an asset. Such a code can be used to identify the asset and facilitate the tracking or cataloging of the asset. Additionally, in some embodiments, the code can be used to access one or more of the online components.

The provider interface 120 is configured to be accessed and used by a provider of an asset. The asset can be any suitable asset, including a plant-related asset. In some embodiments, the asset can be associated with the code described above. The provider can be any suitable provider of one or more assets, including a retailer, a landscaper, and/or the like. In some embodiments, the provider interface 120 is a graphical user interface that displays information requested by the provider and/or receives information input by the provider. For example, the provider interface 120, after having received a request from the provider, can retrieve information from the database 116 and display that information on, for example, a computer monitor or other like device. Likewise, the provider can input information into the provider interface 120 and, upon command, send the input information to the database 116 for storage, as described in more detail herein. The provider interface 120 can be configured to operate on, for example, a personal computer, television, PDA, or any other media viewing device or set of devices capable of presenting media.

The consumer interface 130 is configured to be accessed and used by a consumer of an asset. In embodiments where the consumer purchased the asset, the consumer may have purchased the asset from the provider associated with the provider interface 120. The consumer can be, for example, a landscaper, a gardener, or a recipient of a purchased product. Similar to the provider interface 120, the consumer interface 130 can be a graphical user interface that displays information requested by the consumer and/or receives information input by the consumer. In this manner, the consumer interface 130 operates in a manner similar to the provider interface 120. The provider interface 120 can be configured to operate on, for example, a personal computer, television, PDA, or any other media viewing device or set of devices capable of presenting media. In some embodiments, the consumer interface 130 can only be accessed by a consumer having purchased a product associated with the code described above. In this manner, the code provides the consumer access to the consumer interface 130.

The social network 140 is configured to be accessed and used by the providers and/or the consumers discussed above. The social network 140 can be accessed by the provider via the provider interface 120. Similarly, the consumer can access the social network 140 via the consumer interface 130. In this manner, the social network 140 can potentially connect the consumer and the provider. The term “connect” as used herein is intended to refer to a virtual connection between two entities (e.g., users). In some embodiments, the social network 140 is only accessible to the providers and/or consumers that are authorized to access the provider interface 120 and/or consumer interface 130, respectively, as described in more detail herein. In other embodiments, the social network 140 can be publicly or semi-publicly accessible such that non-affiliated entities can access the social network 140.

The social network 140 is configured to provide asset-related content. Said another way, the content available on the social network 140 corresponds to the type of asset sold by the provider and purchased by the consumer. For example, in embodiments where the provider sold the consumer sunflower seeds, the content available on the social network 140 could be specific to sunflower-related content. In other such embodiments, the content available on the social network 140 could relate to a broader genus than just sunflowers, such as, for example, plants. In this manner, the content in the social network 140 would be specific to plant-related content. Such content can include user-created content, content created exclusively for the social network 140, content pulled from the Internet or other source and made available on the social network 140, and/or the like.

The social network 140 is an interface that operates similar to the provider interface 120 and the consumer interface 130. The social network 140 can be configured to retrieve information from the database 116 and display the information on, for example, a display screen. Similarly, the social network 140 can be configured to send information to the database 116 for storage. In some embodiments, the social network 140 is not a separate interface that a user can access from the provider interface 120 or the consumer interface 130. Rather, the provider interface 120 and the consumer interface 130 are each integrated with the social network 140 (see, for example, consumer interface 630 and provider interface 720).

Unlike the provider interface 120 and the consumer interface 130, however, the social network 140 can have platform-like attributes. For example, the social network 140 can host and/or execute numerous applications that the consumer and/or producer can access and use. The social network 140 can include such applications as forum(s), blog(s), and/or calendar(s). Additionally, the social network 140 can allow consumers and/or producers to create content, which is then stored in the database 116 and subsequently made available to other users on the social network 140 for viewing. A consumer can, for example, blog about a specific content, create a personal webpage, email, post status updates and/or the like.

Further, the social network 140 can allow its users, either consumers or producers, to interact with each other through various applications. For example, the social network 140 can have “chat” capabilities (e.g., video, text messaging or instant messaging) where two remote users communicate with each other in real-time. In other examples, the social network 140 can include “friending” or “following” functionality where a consumer on the social network 140 (typically one with a personal webpage) requests “friendship” from another user or chooses to “follow” the actions of the other user. In some embodiments, acceptance of a “friendship” request can allow the acceptor or requestor access to private information about the opposite party. The social network 140 can have similar functionality where a consumer or other user chooses to become a “fan” of a provider (e.g., a local nursery). In this manner, the fan is endorsing/supporting the provider and/or its assets for sale.

In general, the social network 140 can include one or more of the following functionalities: provider-consumer interaction, blog and/or journal creation, “friending” and/or “following” (as discussed above), group creation and/or participation, forum (or message board) creation and/or participation (e.g., posting), personal page creation (e.g., including personal or company information), utilization of RSS feeds (i.e., Really Simple Syndication feeds), contests and/or games, user activity updates (e.g., an alert when a user has posted to a message board), uploading and/or creating asset-related images, videos, audio recordings and/or drawings about assets, edited and/or non-edited asset-related content aggregation, calendar event listings, micro-blogging, third-party applications and/or widgets (e.g., third-party applications and/or widgets 112), a asset-related retail store and/or the like.

Unlike the applications discussed above that can run on the social network 140, the third party applications and/or widgets 112 illustrated in FIG. 1 are configured to execute directly from the online platform 112. These third party applications and/or widgets 112 can include feeds from any one of the online or offline components including status updates, photographs, and other like information discussed above.

Although the third party applications and/or widgets 112 are illustrated and described above as being executable from the online platform 110, in other embodiments, the third party applications and/or widgets 112 can be executed in the provider interface 120, the consumer interface 130 and/or the social network 140.

In use, a provider (e.g., a local plant nursery owner) accesses the provider interface 120 on the Internet. The provider can do this, for example, by logging on to the online platform 110 or directly logging on to the provider interface 120. Once the provider has accessed the provider interface 120, the provider can input information into the provider interface 120. Depending on the instructions given by the provider, the provider interface 120 can send that input information to the database 116 for storage, or can use that input information to retrieve other information from the database 116. For example, as described in more detail herein, a provider wanting to read information about sunflowers can input the word “sunflower” and instruct the provider interface 120 to retrieve all the information from the database 116 related to sunflowers. In embodiments where the provider interface 120 is a graphical user interface (GUI), the retrieved information will be displayed on the GUI for the provider. Similarly, the provider can also input a code (e.g., the code discussed above) associated with an asset sold by the provider. Using this code as an identifier, the provider interface 120 can retrieve information from the database 116 that is associated with that asset. If the asset were, for example, a rose, then the provider interface 120 would display all the information from the database 116 related to roses. The consumer can perform similar functions from the consumer interface 130.

As discussed in more detail herein, the provider, via the provider interface 120, can access the social network 140. Here, the provider can, for example, post advertisements for his business, read reviews written by his customers about his business, set up a website for his business, or read what other consumers are writing about particular products. Similarly, the consumer, via the consumer interface 130, can access the social network 140. The consumer can, for example, post any questions s/he may have regard the asset, search for publications relating to the asset, or chat with another consumer about their experiences with growing a particular flower.

Although the social network 140 is illustrated and described above as being a component of a hardware or software architecture (i.e., the online platform 110), the social network 140 should be understood as also having a relationship-based component. Meaning, the social network 140, in addition to be an architecture component, is representative of a community of users sharing similar interests and goals. This is exemplified in the discussion above related to content, i.e., the content provided by the social network 140 is limited so that the only users that are accessing that content are users that desire information related to that content.

In some embodiments, the social network 140 component of the online platform 110 is itself a platform capable of executing applications while itself running on the online platform 110. In some such embodiments, the social network 140 can be separate from the online platform 110. Said another way, the social network 140 can exist independently from the online platform 110.

FIG. 2 is a schematic illustration of a provider interface 220 of a system (e.g. system 100). In some embodiments, the provider interface 220 can be executable from a platform (e.g., platform 110). The provider interface 220 can function online over an intranet or Internet, or it can function offline. The provider interface 220 can be configured to operate on, for example, a personal computer, television, PDA, or any other media viewing device or set of devices capable of presenting media, as described above. Additionally, the provider interface 220 is configured to communicate with the social network 140 illustrated and described above with reference to FIG. 1. In some embodiments, however, the provider interface 229 can be configured to communicate with any social network described herein.

The provider interface 220 includes a code generator and print engine (CGPE) 222, an asset details interface 224, and a provider account management (PAM) interface 226. The provider interface 220, which can be, for example, a GUI, is configured to be used and accessed by one or more providers. A provider can be an individual (e.g., a landscaper or an independent vendor) or a business (e.g., a nursery, garden center, farm, or store) selling one or more assets. Although not illustrated in FIG. 2, the provider interface 220 is associated with one or more provider accounts. Each provider using the provider interface 220 can have their own designated provider account that is linked to information specific to that provider. Such information can include, for example, the name of the provider (e.g., the company name, a name of a company's representative, and/or an individual vendor's name), a primary address of the provider (e.g., an email address and/or a physical address), one or more alternate addresses of the provider, the GPS coordinates of the company, a description of the type of business operated by the provider, a description of the type of assets sold by the provider, a business logo, any other usernames or passwords associated with the provider account, and/or the like. When a provider accesses the provider interface 220, the provider is accessing their specific provider account. As described below, the provider account has access to the PAM interface 226, the asset details interface 224, and the CGPE 222 so that the provider can utilize each of these functions.

The PAM interface 226 is configured to be used by the provider to manage his or her provider account. The PAM interface 226 can include management tools, such as a marketing application or widget, an asset inventory analysis application or widget, a financial analysis application or widget, Customer Relationship Management (CRM) tools, and/or the like. In embodiments where a provider account can be accessed by more than one user (e.g., the President of a company and a Store Manager of the company), the PAM interface 226 can include administrative functionality. In this manner, the administrator of the provider account (e.g., the President of the company) can monitor the provider account and change settings, as necessary, to, for example, limit the information or functionality available to the other users of the provider account. Additionally, in some embodiments, the information associated with the provider account can be added, edited, or deleted via the PAM interface 226. The PAM interface 226 can send the updated information to the database 116 for storage.

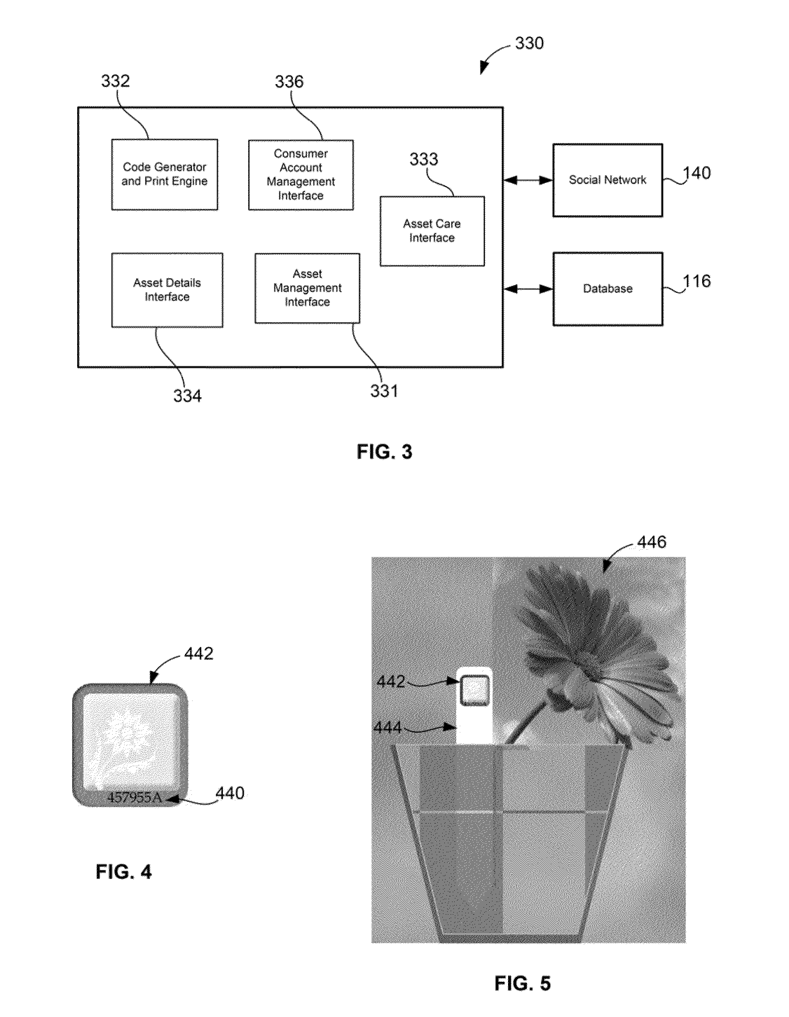

In some embodiments, the PAM interface 226 can create one or more consumer accounts that are associated with and accessible via a consumer interface (e.g., the consumer interface 330 shown in FIG. 3). As will be discussed in more detail herein, a consumer account can be linked to information specific to a particular consumer including information related to the asset or assets purchased by the consumer. The provider of the asset purchased by consumer can create or activate an account for that consumer using the PAM interface 226. In some such embodiments, the account created by the provider for the consumer can include information specific to the asset purchased.

The asset details interface 224 is configured to provide the provider with detailed information about the assets within the provider's inventory. Such information can include, for example, the species of the asset, the genus of the asset, the name of the asset, the code or codes associated with the asset (e.g., the code generated by the CGPE 222), information related to the wholesaler of the asset, the farm or other facility where the asset originated, the price of the asset (e.g., the wholesale price and/or the retail price), any instructions specific to the asset (e.g., care instructions or manuals), and/or the like. In some embodiments, the asset details interface 224 can provide information related to assets previously in the provider's inventory, future assets (e.g., assets that have been ordered but not yet received), the assets in a particular inventory (e.g., the inventory of assets at a particular store when there are many stores), and/or the like.

The asset details interface 224 is configured to communicate with the database 116. In this manner, the asset details interface 224 can retrieve information related to the particular asset(s) in the provider's inventory from the database and display the information on, for example, a display screen. In some embodiments, the provider can run searches for particular assets using the asset details interface 224. The results of those searches can, for example, include information related to assets within the provider's inventory as well as assets outside of the provider's inventory. In some embodiments, the provider can add, change, or delete information related to the assets in the asset details interface 224. For example, when a new shipment of assets arrives, the provider can upload or manually input the new asset information into the asset details interface 224. Such information can then be sent and stored in the database 116.

The CGPE 222 is configured to generate one or more codes for each of the assets available for purchase by the provider. In some embodiments, the CGPE 222 can communicate with the asset details interface 224 to obtain information on which assets require codes to be generated. Once codes are generated for those particular assets, the CGPE 222 can, in some embodiments, send the codes to the asset details interface 224 for use in future searches or look-ups. In other embodiments, however, the CGPE 222 can communicate with the database 116 directly to obtain a listing of the assets that require codes to be generated. In such other embodiments, the CGPE 222 can send the generated codes to the database 116 to be stored.

The CGPE 222 can generate any suitable type of code. For example, the CGPE 222 can generate an alphanumeric code, a bar code, a numeric code, a code containing symbols, or any combination thereof. The code can include, for example, at least a portion of the name or type of the asset, at least a portion of the date or time the code was generated, at least a portion of the name of a facility or location associated with the asset, or any combination thereof. In some embodiments, the codes can be randomly generated and/or sequentially generated. A code can be generated to be common to a particular genus or species of asset. A code can also be generated to be unique to that particular asset (i.e., no other asset will have that same code). In some embodiments, the CGPE 222 can generate multiple codes at one time (i.e., batches). Said another way, the provider can request that codes be generated for multiple assets at once. In other embodiments, the CGPE 222 can generate a single code at a time. Said another way, the provider can request that a code be generated for a single asset.

Once the CGPE 222 has generated the codes, the codes can be displayed on, for example, a display screen. The provider can then choose to print the codes in any suitable manner. The CGPE 222 includes printing functionality that facilitates the printing of the codes. The codes can be printed by the provider using a personal printer or the codes can be printed at another facility and then sent to the provider. The CPGE 222 can print the codes on standard labels or on any other type of labels (e.g., custom labels). The CPGE 222 can format the printing of the codes, for example, depending on the surface (e.g., plastic, paper, rubber, etc.) on which the codes will be printed. The CPGE 222 can also format for batch printing or the like.

In some embodiments, it may not be necessary to use the print engine after the codes are generated. Said another way, in some embodiments, the codes do not have to be printed. For example, in some embodiments, a code that is generated for a particular asset can be solely virtually associated with that particular asset. In the examples discussed above, the code is printed out with the purpose of physically associating the code with the asset (e.g., physically coupling the code to the asset). In this embodiment, however, the there is no such physical association between the code and the asset. In embodiments where the code is printed out and physically associated with the asset, the code can also be virtually associated with the asset.

Although the CGPE 222 is described above as associating the codes it generates with the assets, in other embodiments, the CGPE 222 can generate codes independent of the assets. Said another way, the CGPE 222 can generate a listing of codes without any information about the assets. The provider, for example, can associate the codes with the assets after the codes have been generated.

Although the CGPE 222 is illustrated and described above as being a component of the provider interface 220, in other embodiments, the provider interface 220 does not include a CGPE 222. In some such embodiments, the system (or the provider interface 220 itself) can include functionality that allows the provider to place an order for codes. Once the codes are processed by the system, the codes can be sent directly to the provider electronically (e.g, via email), or can be printed out on labels and then sent to the provider via mail. In some embodiments, the CGPE 222 can have functionality that allows the provider to place such an order for codes and the codes can be delivered to the provider in the same or similar manner.

The PAM interface 226, the asset details interface 224, and/or the CGPE 222 can be, for example, a GUI that pops up separately from the provider interface 220 on, for example, a display screen. In some embodiments, the PAM interface 226, the asset details interface 224, and/or the CGPE 222 can be part of the same GUI as the provider interface 220. In some embodiments, a hyperlink to the PAM interface 226, the asset details interface 224, and/or the CGPE 222 is available on the provider interface 220 so that the provider needs only to click on the hyperlink to access the respective PAM interface 226, the asset details interface 224, or the CGPE 222.

FIG. 3 is a schematic illustration of a consumer interface 330 of a system (e.g. system 100). In some embodiments, the consumer interface 330 can be executable from a platform (e.g., platform 110). The consumer interface 330 can function online over an intranet or Internet, or it can function offline. The consumer interface 330 can be configured to operate on, for example, a personal computer, television, PDA, or any other media viewing device or set of devices capable of presenting media, as described above. Additionally, the consumer interface 330 is configured to communicate with the social network 140 illustrated and described above with reference to FIG. 1. In some embodiments, however, the consumer interface 330 can be configured to communicate with any social network described herein.

The consumer interface 330 includes a code generator and print engine (CGPE) 332, an asset details interface 334, a consumer account management (CAM) interface 336, an asset management interface 331, and an asset care interface 333. The asset details interface 334 has the same structure and operation as the asset details interface 224 in FIG. 2 and, therefore, is not described in detail herein.

The consumer interface 330, which can be, for example, a GUI associated with a network, is configured to be used and accessed by one or more consumers. A consumer can be an individual having purchased an asset from a provider or received an asset (e.g., as a gift), or a public or private entity (e.g., a school, a library, or a government agency). Although not illustrated in FIG. 3, the consumer interface 330 is associated with one or more consumer accounts. Each consumer using the consumer interface 330 can have their own designated consumer account that is linked to information specific to that consumer. Such information can include, for example, the name of the consumer, the name of the provider(s) of the asset(s) (e.g., the company name, an individual vendor's name, and/or the wholesaler), an address of the consumer (e.g., an email address and/or a physical address), an address of the provider (e.g., an email address and/or a physical address), a personal photograph of the consumer, any relevant personal information of the consumer, any other usernames or passwords associated with the consumer account, and/or the like. When a consumer accesses the consumer interface 330, the consumer is accessing their specific consumer account. As described below, the consumer account has access to the CGPE 332, the asset details interface 334, the CAM interface 336, the asset management interface 331, and the asset care interface 333 so that the consumer can utilize each of these functions.

In some embodiments, the consumer account can be created on the consumer interface 330 by a consumer after having purchased or received an asset. In some such embodiments, the consumer can be required to use the code associated with the purchased/received asset to create the account. Said another way, in some embodiments, the consumer interface 330 will not authorize access to or creation of a consumer account unless the consumer has a code associated with the asset. In some embodiments, however, a consumer without a code (or a potential consumer also without a code) can set up a temporary consumer account via the consumer interface 330. In other embodiments, the provider (from whom the asset was purchased) can create and pre-populate a consumer account for the consumer. After having created the consumer account, the provider can upload information related to the asset(s) purchased and information specific to the provider for the consumer's reference and future use. In such an embodiment, the consumer can access the consumer account created by the provider using the code associated with the asset. The consumer need not create a new account after subsequent asset purchases. In other words, a consumer account needs to only be created once. A consumer, however, may opt to create additional accounts, for example, to distinguish between assets purchased from different providers.

The CAM interface 336 has a similar structure and operation as the PAM interface 225 in FIG. 2. The CAM interface 336 is configured to be used by the consumer to manage his or her consumer account. The CAM interface 336 can include management tools such as an asset inventory analysis application or widget, or designer tools such as a landscape designer application or widget, an interior plantscape designer application or widget, and/or the like. In some embodiments, the CAM interface 336 can have purchase capabilities that allows the consumer to make purchases of additional assets via e-commerce. In embodiments where a consumer account can be accessed by more than one user (e.g., patrons of a public library or students at a school), the CAM interface 336 can include administrative functionality. In this manner, the administrator of the consumer account (e.g., a librarian or a principal) can monitor the consumer account and change settings, as necessary, to, for example, limit the information available to the other users of the consumer account. Additionally, in some embodiments, the information associated with the consumer account can be added, edited, or deleted via the CAM interface 336. The CAM interface 336 can send the updated information to the database 116 for storage.

The asset management interface 331 is configured to be used by the consumer to manage his or her asset inventory. Additionally, the asset management interface 331 can track, promote, and offer suggests on maintaining the asset. In the context of plants as an asset, the asset management interface 331 can allow a consumer to input and store information related to the plant asset. Such information can include, for example, the stability of the plant (e.g., weak), the weather conditions affecting the plant on a particular day (e.g., frost or a heavy downpour), the average amount of sunlight the plant receives in a given day, the location of the plant in relation to other plants or structures, bloom information, and/or the like. Additional information can include, for example, the geographic location of the plant (e.g., the zip code or state), the topography of the surrounding area, the GPS coordinates of the plant's location or the consumer's property, and/or the like. Based on the information input into the asset management interface 331, the asset management interface 331 can track the health of the plant. In some embodiments, the asset management interface 331 can provide the consumer with suggestions on where to move the plant (e.g., if it is not receiving enough or receiving too much sunlight), how to care for the plant, and/or what other plants are compatible with the consumer's plant.

In some embodiments, asset management interface 331 can be configured to communicate with one or more sensors associated with a plant. In some such embodiments, the sensors can be attached directly to the plant or can be located proximate the plant. The sensors can collect data related to the health of the plant (e.g., sunlight absorption or water absorption) and report the collected data to the asset management interface 331. The sensors and the asset management interface 331 can communicate with each other wirelessly or via a wired connection. The data the asset management interface 331 receives from the sensors can be stored in the database 116 for reference or future use.

The asset care interface 333 is configured to provide the consumer with detailed information about the proper care for a specific asset. In some embodiments, the asset care interface 333 and the asset management interface 331 can be combined and/or operate as a single interface such that only one interface is necessary. In some embodiments, the consumer interface 330 does not include the asset management interface 331. In other embodiments, however, the consumer interface 330 does not include the asset care interface 333.

The asset care interface 333 provides the consumer with interactive functionality for caring for their assets including, but not limited to, care reminders and care tips. These reminders and tips can be generated based on sensor information (as described above), a generic care schedule, or a consumer-identified care schedule. The asset care interface 333 can interact with the asset management interface 331 to personalize care reminders for a specific consumer and asset. In some embodiments, the asset care interface 333 can include one or more text boxes where a consumer can input information related to the asset. The asset care interface 333 can generate a response in the form of a tip, alert, reminder, suggestion or instruction based on the input information. For example, the asset care interface 333 can prompt the consumer to input information as to whether the soil around their plant is dry. If the consumer specifies that the soil is not dry, the asset care interface 333 will postpone sending the consumer instructions to water their plant. The asset care interface 333 can send the input information and/or its generated response to the database 116 for storing and future use.

The CPGE 332 has a structure and operation that is similar to the CGPE 222 in FIG. 2 in that the CGPE 332 is used to generate and print out codes. Unlike the CGPE 222, however, the CGPE 332 is tailored for use by the consumer instead of the provider. In most instances, the consumer will have purchase an asset that has a code generated by, for example, the CGPE 222 in FIG. 2. The consumer using the consumer interface 330 can use the CGPE 332 to generate codes for any byproduct or offspring that results from that purchased asset. For example, the consumer can purchase a packet of grape seeds that have a code generated by the CGPE 222 in FIG. 2. Once the grape seeds germinate, the consumer can use the CGPE 332 to generate and print a code for the grapes grown from those particular grape seeds. Moreover, the consumer can use the CGPE 332 to generate and print a code for any additional product developed from those grapes (e.g., wine). In this manner, any byproduct or offspring of the asset can be added to the consumer's inventory and tracked in the same manner as the originally purchased asset.

Once a code is generated for the byproduct or offspring of a particular assets, the CGPE 332 can, in some embodiments, send the code (or codes) to the asset details interface 334 for use in future searches or look-ups. In some embodiments, the CGPE 332 can communicate directly with the database 116 and send the generated codes to the database 116 to be stored. In this manner, the provider of the originally purchased asset can obtain information about the related byproducts or offspring from the database 116. In some embodiments, the consumer interface 330 does not include the CGPE 332.

In embodiments where the provider created the consumer's account, the provider can continue to access and update the information in the consumer's account throughout the existence of the consumer account (unless the consumer specifies otherwise). For example, if the consumer purchased another asset from the provider at a later date, the provider could access the consumer's account and update the information in the account to reflect the new purchase. In embodiments where the provider is a landscaper, the landscaper can access and update the information in the consumer's account related to, for example, on-going landscaping on the consumer's property. The landscaper can include, for example, a layout of the landscape design, a detailed schematic of the landscape (e.g., the location of each type of flower or tree in the landscape design), details regarding any future asset purchases as it relates to the landscape, and/or the like.

As discussed above, the asset or assets purchased by the consumer can be associated (virtually, physically or both) with a code. FIG. 4 is a perspective view of a code 440 generated by, for example, the CGPE 222, and printed onto a label 442. Although the code 440 is printed on the label 442, in other embodiments, the code 440 can be hand-written on the label 442 or transferred onto the label 442 in some other suitable manner. The code 440 can be disposed on the label 442 at any suitable location. The textual size of the code 440 can have any suitable dimension proportional to the label 442.

Although the code 440 illustrated in FIG. 4 is an alphanumeric code, in other embodiments, the code 440 can be any suitable combination of letters, numbers, symbols, bars, shapes or the like. As discussed above, the code 440 can include, for example, at least a portion of the name or type of the asset, at least a portion of the date or time the code 440 was generated, at least a portion of the name of a facility, location or provider associated with the asset, or any combination thereof. An example of such a code can be “CACPT04012010.” This code indicates that the consumer purchased a cactus (“CAC”) from PT Nursery (“PT”) on Apr. 1, 2010 (“04012010”). In this manner, the code is associated with the type of asset, the provider of the asset, and the date the asset was purchased. Another example of a code can be “1111PT,” which indicates that the consumer purchased a flowerpot (“1111”) from PT Nursery (“PT”). In this manner, the code is only associated with the type of asset and the provider of the asset.

In some embodiments, the code 440 can be randomly generated and/or sequentially generated. The code 440 can be common to a particular genus or species of asset. For example, the code 440 can be associated with all the assets (i.e., roses) identified under the Rosa genus. Said another way, all the assets under the Rosa genus would be associated with the same code (i.e., code 440). In another example, the code 440 can be associated with all the assets identified under the Rosa virginiana species, which is a species of Rosa. A code can also be generated to be unique to that particular asset (i.e., no other asset will have that same code).

The label 442 can be any suitable label for being attaching to an asset or any other suitable surface. The label 442 can include an adhesive back such that the label 442 with the code 440 is adhered to the asset or other suitable surface. In some embodiments, the label 442 can be clipped to the asset or other suitable surface. In some embodiments, as shown in FIG. 5, the label 442 with the code 440 is attached to a plant marker 444, which is coupled to an asset 446 (i.e., flowerpot and flower). The code 440, for example, can be associated with the flower 446 disposed in the flowerpot. As shown in FIG. 5, the label 442 with the code 440 does not have to be physically attached to the flower 446 to be associated with the flower 446.

In some embodiments, the asset 446 and the plant marker 444 having the label 442 with the code 440, as shown in FIG. 5, can be purchased from a provider. As such, the code 440 is visible to the consumer and the provider at the time of purchase. In some embodiments, however, the code 440 can be hidden up until or after the time of purchase so that the code 440 is only made available to the consumer (i.e., the code 440 is secret). In some such embodiments, the code 440 can be disposed on the label 442, as shown in FIG. 4, but covered by a removable substance or material so that the code 440 is temporarily hidden. Such a substance or material can include, for example, a tab that can be pealed off to reveal the code 440 or a substance that can be scratched off to reveal the code 440. In some embodiments, the substance used to write or print the code 440 is chemically activated by, for example, water, to reveal the code 440. In other embodiments, the code 440 is written or printed on the receipt or some other proof-of-purchase document instead of the label 442. In yet other embodiments, the code 440 is written or printed directly on the asset instead of the label 442.

As described in more detail herein, the consumer can read the code 440 from the label 442 and use the code 440 to access a consumer account (e.g., the consumer account associated with the consumer interface 330).

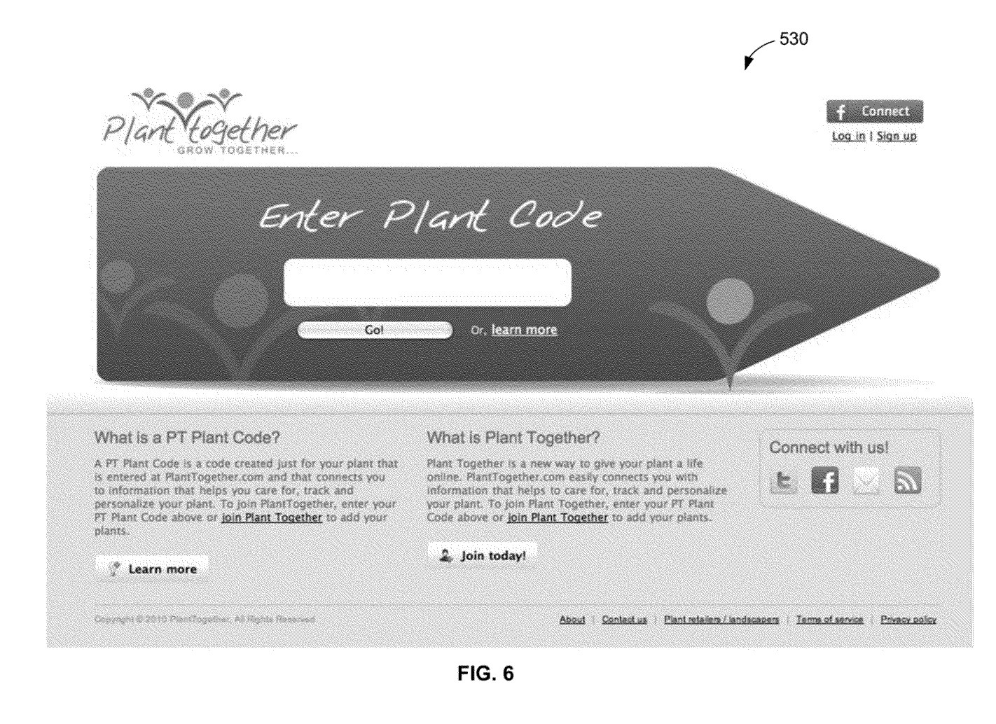

As discussed above, the code 440 can be used by the provider to create a consumer account on a consumer interface (e.g., consumer interface 330). Additionally, the code 440 can be used by the consumer to access the consumer interface and/or to create a consumer account on a consumer interface. FIG. 6 is an example of a graphical user interface in the form of a webpage 530. The webpage 530 includes a text box where the consumer can input a code (e.g., code 440) to access one of the above-identified interfaces. The system (e.g., system 100) receives the code input to the text box once the consumer actuates the “Go!” button. The system then proceeds to obtain all the information associated with the code from a database (e.g., database 116). This information can then be displayed on the webpage 530 and viewed by the consumer.

Once the information is retrieved from the database and displayed for the consumer, the consumer can choose to simply view the displayed information without taking any other action, to access the consumer interface and add the displayed information to their pre-existing consumer account, or to create a consumer account if one does not already exist. In embodiments where the provider of the asset has already created an account for the consumer, entering the code into the text box of the webpage 530 and actuating the “Go!” button can automatically log the consumer into the provider-created consumer account. In this manner, the webpage 530 operates as a portal to a first-timer user's consumer account.

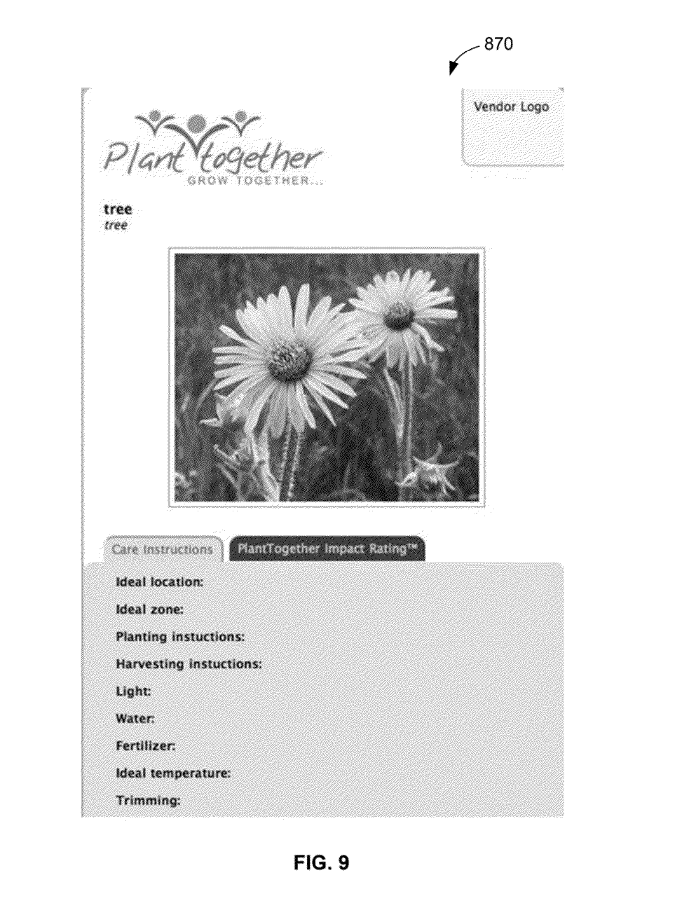

In some embodiments, the information can be presented to the consumer in the form of a plant card (e.g., plant card 870 shown in FIG. 9). As will be discussed in more detail below, the consumer can save the plant card to their consumer account such that all the information from the plant card is available to the user via their consumer account.

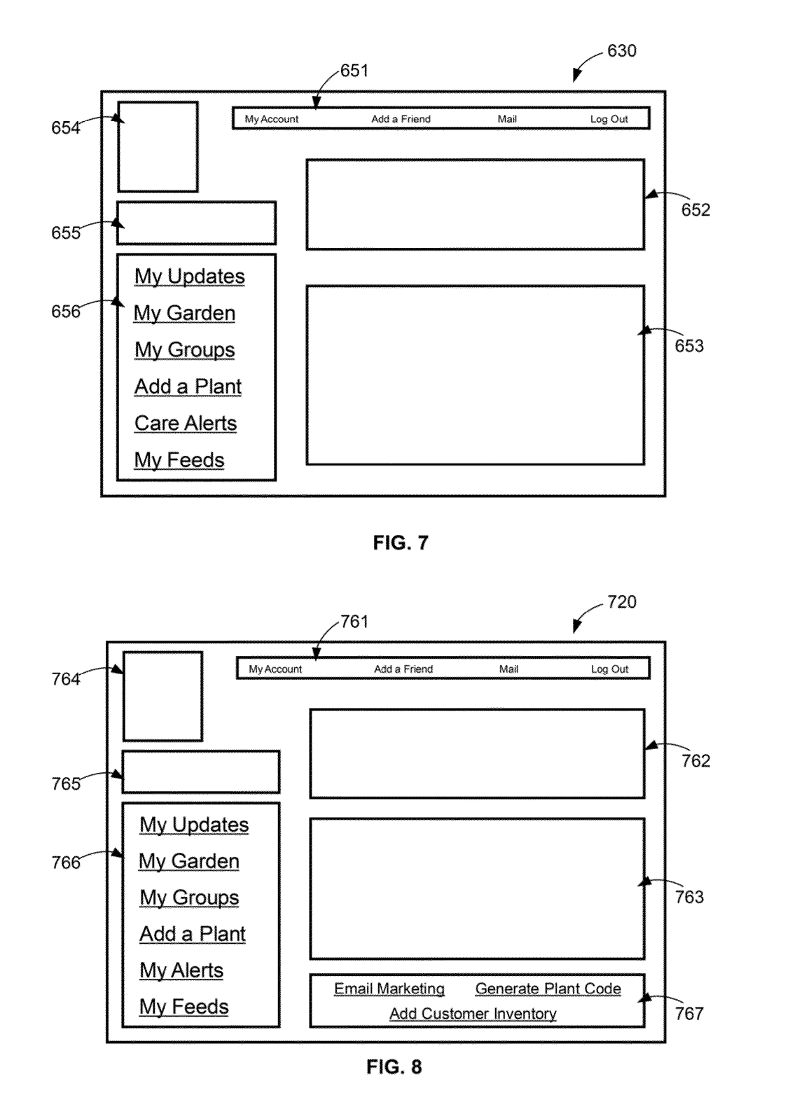

FIG. 7 is a schematic illustration of a consumer interface 630 configured to display information specific to a consumer once the consumer has provided the appropriate credentials to access the system (e.g., system 100). The consumer interface 630 has the same structure and backend operation as the consumer interface 330 shown in FIG. 3. As shown in FIG. 7, the consumer interface 630 is a graphical user interface and can operate on any suitable media viewing device capable of presenting media, such as, for example, a computer monitor. In this particular embodiment, the consumer interface 630 is integrated with a plant-related social network (not illustrated) that has functionalities similar to the functionalities described above with respect to the social network 140 shown in FIG. 1. In this manner, the consumer interface 630 is configured to operate as a centralized hub for consumer interactions and activity on the plant-related social network.

The consumer interface 630 can include, for example, a picture of the user (e.g., displayed in indicia box 654), the user's personal information (e.g., displayed in indicia box 655), a space where a user can input their personal updates (e.g., displayed in indicia box 652), and a feed where the user's updates are displayed along with updates and feeds from the user's plants, friends and other sources (e.g., displayed in indicia box 653 upon actuation of the “My Updates” hyperlink). The consumer interface 630 can be configured to provide the consumer-user access to the user's virtual plant garden (e.g., via the “My Garden” hyperlink), selected groups (e.g., via the “My Groups” hyperlink), generated alerts (e.g., via the “Care Alerts” hyperlink), and feeds (e.g., via the “My Feeds” hyperlink). Moreover, the consumer interface 630 can provide the consumer-user access to add-a-plant functionality (e.g., via the “Add a Plant” hyperlink), a user's email (e.g., via the “Mail” hyperlink), login functions (e.g., via the “Log Out” hyperlink), an account management interface (e.g., via the “My Account” hyperlink), a plant-related asset management interface (e.g., via the “My Account” hyperlink), and an plant-related asset care interface (e.g., via the “My Account” hyperlink or the “Care Alerts” hyperlink). In some embodiments, the account management interface, the plant-related asset management interface, and the plant-related asset care interface have the same structure and operation as the CAM interface 336, the asset management interface 331, and the asset care interface 333 of the consumer interface 330 shown in FIG. 3. In this manner, the consumer can use the consumer interface 630 as both a management tool and a social networking tool.

It should be understood that all of the components of the consumer interface 630 and their respective orientations and arrangements, as shown in FIG. 7, are for illustrative purposes only. The consumer interface 630 can have any number of hyperlinks and/or indicia boxes capable of displaying or receiving images or text. In some embodiments, the hyperlinks can be configured to link to internal or external webpages. In some embodiments, the consumer interface 630 can include a hyperlink that links to any one of the interfaces or components discussed above with respect to FIGS. 1 and 3. For example, in some embodiments, the consumer can actuate the “Add a Plant” hyperlink displayed on the consumer interface 630 to access a code generation and print engine or a database similar to the CGPE 332 or the database 116 shown in FIG. 3, respectively.

FIG. 8 is a schematic illustration of a provider interface 720 configured to display information specific to a provider once the provider has provided the appropriate credentials to access the system (e.g., system 100). The provider interface 720 has the same structure and backend operation as the provider interface 220 shown in FIG. 2. As shown in FIG. 8, the provider interface 720 is a graphical user interface and can operate on any suitable media viewing device, such as, for example, a computer monitor. In this particular embodiment, the provider interface 720 is integrated with a plant-related social network (not illustrated) that has functionalities similar to the functionalities described above with respect to the social network 140 shown in FIG. 1. In this manner, the provider interface 720 is configured to operate as a centralized hub for provider-consumer interactions and activity on the plant-related social network.

The provider interface 720 displays indicia boxes 761, 762, 763, 764, 765, and 766 that have substantially the same functionality and content (e.g., hyperlinks) as the indicia boxes 651, 652, 653, 654, 655, and 656 from the consumer interface 630 shown in FIG. 7. Unlike the consumer interface 630, however, the provider interface 720 includes an indicia box 767 with hyperlinks labeled “Email Marketing”, “Generate Plant Code” and “Add Customer Inventory.” The provider can actuate the “Email Marketing” hyperlink to initiate communication with consumers via email. In examples where the provider is a local nursery, an employee of the nursery can actuate the “Email Marketing” hyperlink and proceed to send a mass email with a discount coupon to the nursery's customers.

The provider can also actuate the “Generate Plant Code” hyperlink to access a code generation and print engine having a structure and operation similar to the CGPE 222 shown in FIG. 2. Continuing with the same local nursery example, an employee of the nursery can actuate the “Generate Plant Code” hyperlink and proceed to generate and download codes for new plants received in a recent shipment. After a customer purchases a plant from the recent shipment, for example, the employee can similarly actuate the “Add Customer Inventory” hyperlink on the provider interface 720 to access that consumer's account and add the purchased plant to the consumer's plant inventory. If the consumer does not have a consumer account, the employee can create an account for the consumer and pre-populate the account with the purchased plant's information using an interface accessed by actuation of the “Add Customer Inventory” hyperlink.

It should be understood that all of the components of the provider interface 720 and their respective orientations and arrangements, as shown in FIG. 8, are for illustrative purposes only. The provider interface 720 can have any number of hyperlinks and/or indicia boxes capable of displaying or receiving images or text. In some embodiments, the hyperlinks can be configured to link to internal or external webpages. In some embodiments, the provider interface 720 can include a hyperlink that links to any one of the interfaces or components discussed above with respect to FIGS. 1 and 2.

In some embodiments, a system (e.g., system 100) can generate one or more “cards” based on one or more codes that are entered into a text box of the system's webpage (e.g., webpage 530) or consumer interface (e.g., interface 630). FIG. 9 is an example of a graphical user interface that includes a plant card 870. The plant card 870 can be displayed, for example, on a computer monitor after a consumer enters a code (not illustrated) into the system's webpage or consumer interface, as described above. The plant card 870 includes an image of the plant associated with the code entered as well as information specific to that plant. In some embodiments, the plant card 870 can include an image, contact and general information, a logo and/or a name of the provider from which the plant was purchased. In some embodiments, the plant card 870 has functionality capable of aggregating information specific to that particular plant. Such information can include, but is not limited to, information related to care, planting, harvesting, cooking and interior and exterior landscaping information. The information can be collected via a sensor (as described above) or the consumer can directly input the information into the plant card 870 via text boxes (not illustrated). The information can be collected online or offline.

For example, as shown in FIG. 9, the plant card 870 includes a tab labeled “Care Instructions” and a tab labeled “PlantTogether Impact Rating.” In embodiments where the code is entered into the system's webpage, the consumer can actuate the “Care Instructions” tab so that all of the general care information associated with that particular plant is displayed on the webpage (or other webpage). The consumer can also actuate the “PlantTogether Impact Rating” tab so that all of the general impact rating information associated with that asset is displayed on the webpage (or other webpage). The impact rating information will be discussed in more detail below. If the consumer desires to create a consumer account and include the plant card 870 in the account, the consumer can click on the plant image or actuate another hyperlink (not shown) on the plant card 870 and follow the instructions provided by the system to create such an account. The consumer can perform the same actions if s/he already has a consumer account and desires to add the plant card 870 to the account. The system will prompt the consumer to enter the account information before the plant card 870 is added to the account.

In embodiments where the code is entered into a specific consumer's account on the system's consumer interface, the consumer can actuate the “Care Instructions” tab so that all of the general care information associated with that particular plant is displayed on the consumer interface. The consumer has the additional option of editing the information displayed in the “Care Instructions” tab so that the information is personalized and relates specifically to the consumer's plant. Likewise, the consumer has the option of editing the information displayed in the “PlantTogether Impact Rating” tab once that tab is actuated. The consumer can save the plant card 870 and all of the edits made to the plant card 870 by clicking on the plant image or actuating another hyperlink (not shown) on the plant card 870 and requesting that the plant card 870 be saved. All of the consumer's edits can be sent to a database (e.g., database 116) and stored so that each time the consumer views the plant card 870 it includes the edited information. In some embodiments, the image of the plant on the plant card 870 can be replaced with an uploaded image of the consumer's actual plant.

It should be understood that the number of tabs, the arrangement and orientation of the tabs, as well as the label of the tabs shown in FIG. 9 are for illustrative purposes only. The plant card 870 can have any number of tabs, in any arrangement or orientation, with any suitable label, that can be actuated to display any plant-related information. In some embodiments, the plant card 870 does not include tabs. Rather, the plant card 870 includes hyperlinks or some other mechanism that can be actuated to display relevant plant-related information.

In some embodiments, the system can generate, collect, and display multiple plant cards 870 on the consumer interface. These plant cards 870 can be saved in the same manner described above. When multiple plant cards 870 are saved to a consumer's account, the aggregation of plant cards 870 can be referred to as a “garden” or “plant garden”. For example, the consumer interface can display a link (e.g., the “My Garden” hyperlink shown in FIG. 7) that directs the consumer to a webpage (or other display area) where images of all of the collected plant cards 870 are displayed. In this manner, the consumer can view multiple assets in icon form at one time.

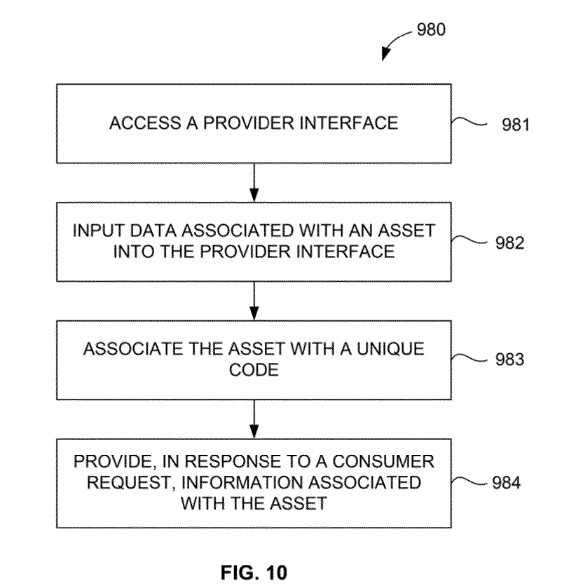

FIG. 10 is a flow chart of a method 980. The method includes accessing a provider interface, 981. The provider interface is associated with a provider having at least one asset for purchase. The provider interface can be any of the provider interfaces illustrated and discussed herein, such as, for example, provider interface 220. The provider can be an individual (e.g., a landscaper or an independent vendor) or a business (e.g., a nursery, garden center, farm, or store). The asset can be any suitable asset, such as, a plant-related asset (e.g., a tree or tree seed) or a livestock-related asset (e.g., bovine). In some embodiments, the provider interface has security functionality such that the provider can only access the provider interface, for example, using a username and/or password. In some embodiments, the provider interface is part of a service and can only be accessed by a subscriber. For example, the provider may have to pay a fee to access the provider interface.

Data associated with the asset is input into the provider interface, 982. Then, the provider interface is configured to display a unique code generated based on the data input. The data can be any identifying data associated with the asset, such as, a genus of the asset, information related to the provider, a date the asset was purchased by a consumer, a date the unique code was generated, and/or the like. The code can be any of the codes illustrated and discussed herein. For example, the code can be an alphanumeric code (see FIG. 4). Further, the code can be generated in any suitable manner. For example, the code can be generated by a CGPE (e.g., CGPE 222). In some embodiments, the code is not a unique code.

The asset is associated with the unique code, 983. In some embodiments, the associating includes providing the consumer with the unique code at the time of purchase. In such an embodiment, the unique code can be printed on the receipt and given to the consumer, or the unique code can be on a label and given to the consumer separately. In some embodiments, however, the associating includes coupling a marker with the unique code to the asset such that the asset is purchased with the marker. As shown in FIG. 5, the marker with the code can be placed in the flowerpot with the flower (i.e., asset). In other embodiments, the code with the marker and/or label can be physically coupled (fixedly or removably) to the asset itself.

In some embodiments, the associating includes uploading the unique code on the provider interface such that the unique code is accessible on a consumer interface (e.g., consumer interface 330). The consumer interface can grant the consumer access to information associated with the asset based on the unique code. Similarly stated, the consumer can only access the consumer interface if s/he has and uses the unique code.

Information associated with the asset is provided in response to a consumer request, 984. The information associated with the asset is retrieved from a database accessible via the provider interface. Such information can include at least one of a genus of the asset, a species of the asset, a suggested care regimen for the asset, historical data, familial data, troubleshooting data, a suggested landscaping that includes the asset, a suggestion of another asset compatible with the asset, and/or the like.

The database can be any suitable database and can store information that has been pulled from the Internet or other reliable source, or entered by the provider. In some embodiments, the database can be accessible via a consumer interface (e.g., consumer interface 330). In some such embodiments, the consumer interface can be configured to provide, for example, the consumer, access to a plant-related social network (e.g., social network 140). The social network can be operative to virtually connect the consumer with one or more providers (including the provider above) and/or one or more other consumers (including, for example, potential consumers).

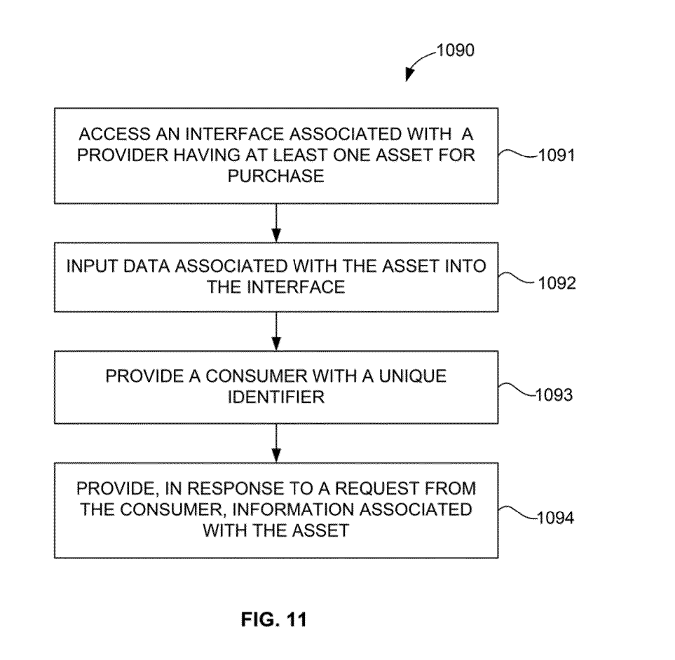

FIG. 11 is a flow chart of a method 1090. The method includes accessing an interface associated with a provider having at least one asset for purchase, 1091. The interface can be, for example, a provider interface, such as provider interface 220. The provider can be any of the providers discussed herein. The asset can be any of the assets discussed herein. In some embodiments, the provider can access the interface. In some such embodiments, the provider can be required to subscribe to a Website with the interface before the provider can access the interface. In some embodiments, the subscription is a paid subscription, while in other embodiments, the subscription is a free subscription. The Website and/or the interface can be associated with a service provider.

Data associated with the asset is input into the interface, 1092. The data can be any identifying data associated with the asset, as discussed above. The interface is configured to display a unique identifier generated based on the data input. The unique identifier corresponds to the asset or a genus of assets associated with the asset. For example, as discussed above, the unique identifier can correspond to all the assets from the Rosa genus of assets. The unique identifier can be any one of the codes illustrated and described herein. For example, in some embodiments, the unique identifier can be one of a numeric code, an alphanumeric code, or a name of the asset. In some embodiments, the identifier is not unique.

A consumer is provided with the unique identifier, 1093. The unique identifier can be provided to the consumer in any manner described herein. For example, the unique identifier can be printed on the purchase receipt given to the consumer. In some embodiments, the consumer is provided with a marker with the unique identifier (see, for example, FIG. 5) at the time of purchase such that the asset is purchased with the marker. In embodiments where the consumer purchases more than one asset, the consumer can be provided with more than one unique identifiers. In some such embodiments, each unique identifier corresponds to an asset or the genus of assets associated with an asset.

Information associated with the asset is provided in response to a request from the consumer, 1094. The information is retrieved from a database accessible via the interface. Such information can include at least one of a genus of the asset, a species of the asset, a suggested care regimen for the asset, historical data, familial data, troubleshooting data, a suggested landscaping that includes the asset, a suggestion of another asset compatible with the asset, and/or the like. In some embodiments, the information can also include information related to the provider of the asset. As discussed above, the database can be any suitable database and can store information that has been pulled from the Internet or other reliable source, or entered by the provider.

In some embodiments, the method 1090 includes associating the unique identifier with the asset. In this manner, the unique identifier would correspond to the asset or genus of assets associated with the asset once the unique asset is associated with the asset. In some embodiments, the unique identifier can be physically associated with the asset as described herein. In other embodiments, the unique identifier can be virtually associated with the asset as described herein.

In some embodiments, the method 190 includes accessing an interface to a plant-related social network (e.g., plant related social network 140). The social network can be operative to virtually connect the provider with one or more consumers (including the consumer above).

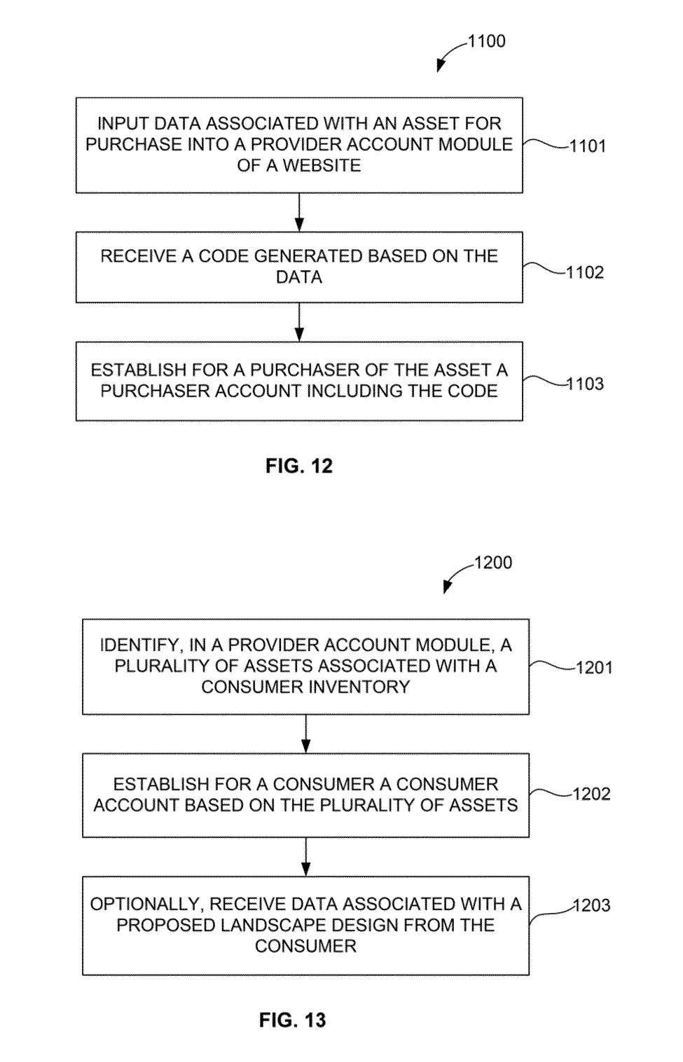

FIG. 12 is a flow chart of a method 1100. The method includes inputting data associated with an asset for purchase into a provider account module of a website, 1101. The website is associated with a provider, such as, for example, a local nursery. The provider, however, can be any of the providers discussed herein. Similarly, the asset can be any of the assets discussed herein, including a plant-related product or a livestock-related product. The data can be any identifying data associated with the asset, as discussed above. The website can be, for example, the online platform 110. In some embodiments, the data can be input by the provider.

The provider account module can be any provider account discussed herein, any provider interface discussed herein, and/or the like. In some embodiments, the provider account module can be configured to provide information associated with the provider. Such information can include, for example, at least one of a name of the provider, an address of the provider, GPS coordinates of the provider, a logo of the provider, an email of the provider, payment data associated with the provider, an inventory of the provider, and/or the like. Additionally, in some embodiments, the provider account module can include more than one provider account. In some such embodiments, each of the provider accounts can be associated with a different provider. For example, one provider account can be associated with a local nursery and another provider account can be associated with farm.

In some embodiments, the provider account module can be configured to provide the provider access to a plant-related social network (e.g., plant-related social network 140). As described herein, the social network can be operative to virtually connect the provider with more than one consumer, including the purchaser.

A code generated based on the data is received, 1102. The code corresponds to the asset or a genus of assets associated with the asset. The code can be any of the codes illustrated and described above. In some embodiments, the code is a unique code. In some embodiments, code is received via at least one the provider account module, an email, mail, or the like. In some embodiments, the code can be received by the provider.

A purchaser account including the code is established for a purchaser of the asset, 1103. The purchaser account is configured to be accessed by the purchaser via a purchaser account module of the website. The purchaser account is configured to provide the purchaser with information associated with the asset. The purchaser can be, for example, any of the consumers described herein. The purchaser account module can be, for example, any of the consumer interfaces described herein. The information associated with the asset can include any of the information described herein.

In some embodiments, the purchaser account module can include more than one purchaser account, including the purchaser account. Each of the purchaser accounts can be associated with a different purchaser. For example, in some embodiments, one purchaser account can be associated with an individual purchaser and another purchaser account can be associated with business (e.g., public library). In some embodiments, the purchaser account can be configured to provide the purchaser access to a plant-related social network, as described herein. The plant-related social network can be operative to virtually connect the purchaser with, for example, one or more providers (including the provider), or one or more other purchasers.

In some embodiments, the purchaser account can be established by the provider.

FIG. 13 is a flow chart of a method 1200. The method includes identifying, in a provider account module, a plurality of assets associated with a consumer inventory, 1201. The provider account module is associated with a provider of at least a portion of the consumer inventory. The assets can be any of the assets described herein. In some embodiments, at least one asset can be a plant-related product. In some embodiments, the provider can be, for example, at least one of a provider of each asset from the plurality of assets or a designer of a landscape associated with the plurality of assets. In other embodiments, the provider can be any of the providers described herein.

In some embodiments, the assets can be identified by uploading a unique code generated for each asset into the provider account module. Additionally, in some embodiments, the assets can be identified by uploading identifying information related to each asset into the provider account module. In some such embodiments, the identifying information related to each asset can be, for example, a code.

A consumer account is established for a consumer based on the plurality of assets, 1202. The consumer account is configured to be accessed by the consumer via a network. Additionally, the consumer account is configured to provide data associated with at least one of the assets from the plurality of assets. Such data is retrieved from a database based on the identification of the plurality of assets. The data can include, for example, at least one of a unique code generated for each asset from the plurality of assets, a virtual representation of a landscape design including at least one asset from the plurality of assets, a location of an asset from the plurality of assets in the landscape design, a genus of assets from the plurality of assets, a species of assets from the plurality of assets, a total amount of assets in the plurality of assets, data associated with the consumer inventory, recommendations based on the consumer inventory, recommendations based on the landscape design, recommendations based on a location of an asset from the plurality of assets in the landscape design, a troubleshooting guide based on the consumer inventory, and/or the like. In some embodiments, the data can also include data related to the provider of the plurality of assets.

In some embodiments, the database can be configured to store information associated with, for example, at least one of a provider of each asset from the plurality of assets, a designer of a landscape associated with the plurality of assets, and/or the like. Additionally, in some embodiments, the database can be configured to be populated with the data by, for example, at least one of downloading information from a website, receiving information from the consumer via the consumer account, receiving information from a plurality of other consumers, receiving information from the provider via the provider account module, receiving information from a plurality of other providers, and/or the like.

In some embodiments, the provider account module and/or the consumer account can be configured to receive sensor data from a sensor associated with one or more of the assets. The sensor data can, for example, be associated with a status of the asset as described herein.

In some embodiments, the provider account module can be accessed via the network by the provider. In some such embodiments, the provider can have previously subscribed to the provider account module. In some embodiments, the provider access module can be configured to provide the provider access to a plant-related social network as described herein. Similarly, in some embodiments, the consumer account can be configured to provide the consumer access to the plant-related social network as described herein.

In some embodiments, data associated with a proposed landscape design can be received from the consumer, 1203. In some such embodiments, the proposed landscape can include one or more of the assets from the plurality of assets. Additionally, the proposed landscape design can be designed by the consumer on a design module, which is associated with the consumer account and/or the provider account module.

In some embodiments, the consumer inventory can be updated to include additional assets such that each of the additional assets are included in the plurality of assets. In some embodiments, the consumer inventory can be manually updated by the consumer or the provider. In other embodiments, the consumer inventory can be automatically updated through the provider account module.

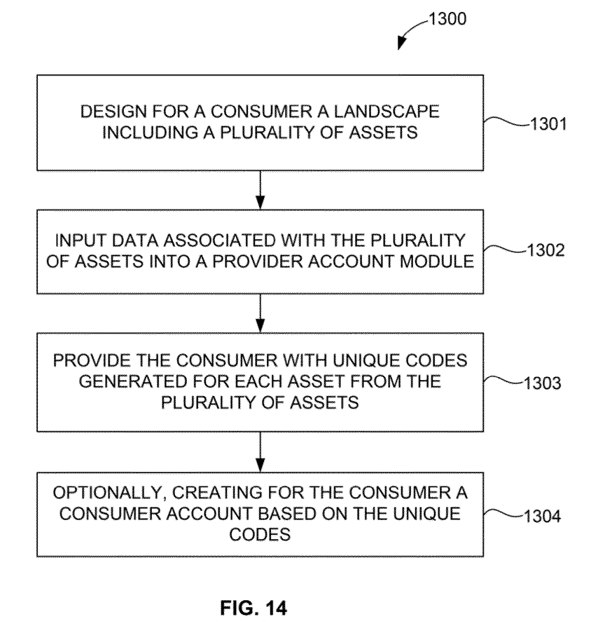

FIG. 14 is a flow chart of a method 1300. The method includes designing for a consumer a landscape including a plurality of assets, 1301. In some embodiments, each asset from the plurality of assets is a plant-related asset. The designing 1301 can be performed by, for example, a landscape designer. In some embodiments, the term “landscape” can refer to outdoor and/or indoor plantscape design. For example, some consumers can choose to grow an indoor garden in addition to or rather than an outdoor garden.

In some embodiments, before the landscape is designed, data associated with a proposed landscape design can be received from the consumer. In some such embodiments, the proposed landscape can include at least one asset from the plurality of assets. Additionally, the proposed landscape can be designed by the consumer on a design module. In some embodiments, the design module can be associated with a consumer interface (e.g., consumer interface 630) and/or a social network (e.g., the plant-related social network 140).

Data associated with the plurality of assets is input into a provider account module, 1302. Then, a unique code is generated for each asset from the plurality of assets based on the input data. The unique code can be any of the codes described herein. In some embodiments, the code is not unique. The data can include, for example, the landscape design, a location of an asset from the plurality of assets in the landscape design, a type of an asset from the plurality of assets, a total amount of assets in the plurality of assets, a total amount of each type of asset in the plurality of assets, and/or the like. In some embodiments, the provider account module can be configured to provide information related to at least one of a provider of each asset from the plurality of assets or a designer of the landscape.

In some embodiments, the provider account module can show graphically what the landscape design will look like at different times of the year (e.g., during different seasons).

In some embodiments, after the data is input into the provider account module, the unique codes generated for each asset from the plurality of assets can be received via the provider account module, a provider email address, and/or a provider mailing address. The data can be input into the provider account, for example, by a landscape designer.

The consumer is provided with the unique codes generated for each asset from the plurality of assets, 1303. The consumer is provided access to a consumer account based on the unique codes. The consumer account is configured to provide the consumer with information related to the landscape design and/or the plurality of assets. Such information can include, for example, the input data, a virtual representation of the landscape design, a provider of each asset from the plurality of assets, an inventory of the plurality of assets, recommendations based on the inventory, recommendations based on the landscape design, recommendations based on a location of an asset in the landscape design, and/or a troubleshooting guide based on the inventory.

In some embodiments, the consumer account can be created for the consumer based on the unique codes, 1304. In some such embodiments, the consumer account can have the unique codes (e.g., stored therein). The consumer account can be created for the consumer by the provider in any manner described herein. In some embodiments, the consumer account is established by the consumer using the unique codes.

In some embodiments, the provider account module and/or the consumer account is configured to receive sensor data from a sensor associated with an asset from the plurality of assets. In some such embodiments, the sensor data can be associated with the status of the asset, as described herein.

In some embodiments, the provider account module is configured to provide a landscape designer (or other provider) access to a plant-related social network. Similarly, in some embodiments, the consumer account can be configured to provide the consumer access to a plant-related social network. The social network can be operative to virtually connect the landscape designer and/or consumer with one or more asset providers, one or more other landscape designers (including the landscape designer above), and/or one or more consumers (including the consumer above).

While various embodiments of the invention have been described above, it should be understood that they have been presented by way of example only, and not limitation. Where methods or other types of movement described above indicate certain events occurring in certain order, the ordering of certain events may be modified. Additionally, certain of the events may be performed concurrently in a parallel process when possible, as well as performed sequentially as described above.

Although the assets are illustrated and described above as being plant-related assets, in other embodiments, the assets can be livestock-related assets. Livestock-related assets can include, for example, any type of meat product (e.g., fish, cattle, chicken, etc.) and/or any by-product resulting from livestock life. A livestock-related product can also include any product related to raising livestock. Such a product can be, for example, any type of feeding for the livestock, housing, equipment, and/or any other system(s) and/or container(s) necessary to raise livestock. Further, a livestock-related product can include any type of educational material (e.g., a book or video) designed to inform a people on a specific type of livestock, an aforementioned livestock-related product and/or the like.

In some embodiments, the consumer interface and/or the provider interface can include functionality that allows an asset to be personalized (e.g., an asset personalization interface). In some instances, an asset purchased from a provider can already include a “personality”—i.e., one or more personality traits. For example, in some embodiments, an asset can have a name, such as “Johnny the Cactus.” The provider can use the personality of the asset to market the asset to consumers. The consumer that purchases that asset can have the option of changing the asset's personality once the asset's information is available to the consumer on the consumer interface. In some embodiments, the asset's personality can be associated with the code. In this manner, the consumer can enter the code into the consumer interface to retrieve information related to the asset's personality and/or engage in personality themed interaction with the representation of the asset (e.g., via the plant card, care alerts, etc.) in the consumer interface.

In some embodiments, the provider can sell the asset to a consumer without a personality attached but the consumer can create the asset's personality once the asset's information is available to the consumer on the consumer interface. The personality that the provider and/or consumer creates for an asset can be included on the respective provider account or consumer account such that the personality can be viewed by other consumers or providers that have authorization to view such information.

In some embodiments, the personalization functionality of the consumer interface and/or the provider interface can allow the respective consumer and/or provider to upload, create or edit personalized asset information such as unique names, unique photographs, a care log, a “garden”, and/or alerts. In some embodiments, an asset can have different personalities that represent the immediate needs of the asset (e.g., when the asset is a plant-related asset). In some such embodiments, a specific personality of the asset can be evident when text (or other indicator) is generated (or becomes visible) to express the care needs of the asset. For instance, if the asset is “Grumpy”, then the text affiliated with the asset could say “Hey buddy, what are you trying to do to me??? Yes, I'm similar to frogs because I like water . . . but I don't want to croak. Don't you think it's time to check on me?” In some embodiments, a personalization interface can communicate with one or more sensors associated with the asset. The sensor, for example, can send a signal when the plant is dry and needs to be watered so that the above text is displayed the next time the user logs into the consumer interface or the provider interface. In some embodiments, however, the text (or other indicator) is sent to the user via email or text message. In other embodiments, the text (or other indicator) is disseminated across other online communication platforms, such as Twitter, Facebook and/or the like.

In some embodiments, the consumer interface is configured to receive data from the consumer indicating that the suggested task has been performed (e.g., that the plant has been watered). For example, the consumer can mark a checkbox or input text into a textbox on the consumer interface. In some embodiments, the consumer can be “rewarded” with virtual prizes (e.g., online trophies, awards, badges, etc.) for caring for their plant. The social network can have contests where the winner is the person who does the best job caring for their plant. In some embodiments, points are awarded each time the consumer indicates that they completed a suggested task or diligently cared for their plant.

In some embodiments, the social network 140 can include gaming functionality or provide the user access to a gaming platform located externally from the online platform 110. The user, for example, can participate in a virtual reality (e.g., with a digital avatar). In some embodiments, the user can virtually “grow” for a plant. Such a program can be advantageous for teaching, for example, school-aged children, how to care for a plant or grow a garden. In turn, the program is promoting sustainability and the ideal of living “green”.

Although the system 100 is illustrated and described herein as having a single database 116, in other embodiments, the system 100 can include a plurality of databases. For example, the system 100 can have a database for information related to the consumer and a separate database for information related to the provider. In some embodiments, the system 100 can have an additional database for information related to assets.

In some embodiments, the provider interfaces and/or consumer interfaces can include one or more security features that limits accessibility to the provider interfaces and/or consumer interfaces, respectively. In such an embodiment, the provider interfaces and/or consumer interfaces can be password protected.

In some embodiments, the CGPE 222 (the code generating functionality, the printing functionality or both) is a pay-to-use option on the provider interface 220. In such embodiments, the provider can be required to pay a certain fee on a per code, per batch, or per use basis. In some embodiments, the use of the CGPE 222 and/or the codes it generates is part of a retail package.

Although the CGPE 222 is illustrated and described above as being a single component of the provider interface 220, in other embodiments, the CGPE 222 can be represented by more than one component of the provider interface 220. For example, in some embodiments, the code generator functionality of the CGPE 222 can operate separately (i.e., as a separate component) from the print engine functionality of the CGPE 222.

In some embodiments, the provider interface 220 can connect to a database maintained by the provider (or another module associated with the provider) to pull or download data stored therein. Such data can then become associated with the provider's account and stored in, for example, database 116, for future use. Such data can include financial data, asset inventory data, customer data, and/or the like.

In some embodiments, the consumer interface 330 can include a code entry interface (not illustrated) where a consumer can input a code. Upon request by the consumer, the code entry interface can search, retrieve and display information related to the code input. The code entry interface can retrieve the information from an associated database (e.g., database 116), the Internet or intranet, or other reliable source.

In some embodiments the asset care interface 333 of the consumer interface 330 can be divided into two levels that can each then be associated with a separate interface. At the first level, the modified asset care interface can include, for example, plant card information or instructions on caring for the asset. In general, the information at the first level of the modified asset care interface is general, but still specific to the asset. At the second level, the information provided by the modified asset care interface is more detailed and tailored to the specific asset. For example, the modified asset care interface can communicate with the CAM interface 336, the asset management interface 331, and/or the asset details interface 334 to more narrowly tailor the care instructions to that specific asset. In some embodiments, the second level can also include some personalization functionality where the consumer can upload care logs, photographs of the asset, their personal nickname for the asset, and/or the like. Further, in some embodiments, the information collected and generated at the second level can trigger alerts. Such alerts can be sent to the consumer for various reasons (e.g., the affect of frost on the asset) Moreover, in some embodiments, the second level can include functionality that enables it to communicate with any of the sensors discussed above.

In some embodiments, after the codes are generated, the codes can be integrated into a Point of Sale (POS) system or Customer Relationship Management (CRM) system owned and/or operated by the provider. In this manner, the code(s) can be printed on a receipt and given to the consumer.

In some embodiments, the system, the consumer interface, the provider interface, and/or the plant-related social network can have environmental tracking functionality. For example, in some embodiments, the system, the consumer interface, the provider interface, and/or the plant-related social network can include a Carbon Offset Tracking System. Such a system can be capable of tracking the carbon dioxide reducing ability of a plant-related asset in addition to the actual or estimated amount of reduced carbon dioxide attributable to that particular plant-related asset. In some embodiments, the code associated with the plant-related asset can be used to track the carbon reduction attributable to that plant-related asset. In an example where the plant-related asset is a tree, the code associated with the tree can be used to track the carbon reducing attributes of the tree over time. In some such embodiments, one or more sensors can be used to facilitate gathering carbon data from or around the plant-related asset. In some embodiments, such a carbon tracking system can be suitable for indoor use. For example, the system can monitor the improvements to interior air quality that may result from a plant-related asset living indoors. Although the Carbon Offset Tracking System has been described above as being intended for carbon tracking and reduction, in other embodiments, the system can track and monitor the reduction or increase of other elements.

In some embodiments, the system (e.g., system 100) can include interfaces or modules related to consulting services and/or marketing services. For example, the company maintaining the system can have consultants on staff. Those consultants can work with the providers to improve the provider's plant-related business. The consultants can, for example, evaluate the provider's website, email distribution tactics, online marketing tactics, etc. and provide suggestions on how to improve those particular aspects of the business. Additionally, the system can include separate marketing functionalities for use by subscribing providers. For example, the system can offer CRM marketing to providers, as well as special offers, incentive marketing, targeted banner advertising, email contact marketing, newsletter marketing, market research, direct consumer contact, blog creation, blog advertising, and/or the like.

In some embodiments, the system, the interfaces, the modules, and/or the social networks can include a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

Although various embodiments have been described as having particular features and/or combinations of components, other embodiments are possible having a combination of any features and/or components from any of embodiments where appropriate. For example, in some embodiments, the provider interface 720 can generate and display one or more of the plant cards 870 shown in FIG. 9.

1-32. (canceled)

33. A method, comprising:
identifying, in a provider account module, a plurality of assets associated with a consumer inventory, the provider account module being associated with a provider of at least a portion of the consumer inventory; and
establishing for a consumer a consumer account based on the plurality of assets, the consumer account configured to be accessed by the consumer via a network, the consumer account configured to provide data associated with at least one of the assets from the plurality of assets, the data being retrieved from a database based on the identification of the plurality of assets.

34. (canceled)

35. The method of claim 33, wherein the provider is at least one of a provider of each asset from the plurality of assets or a designer of a landscape associated with the plurality of assets.

36. The method of claim 33, further comprising:
receiving data associated with a proposed landscape design from the consumer, the proposed landscape including at least one asset from the plurality of assets, the proposed landscape design being designed by the consumer on a design module associated with at least one of the consumer account or the provider account module.

37. The method of claim 33, wherein the data includes at least one of a unique code generated for each asset from the plurality of assets, a virtual representation of a landscape design including at least one asset from the plurality of assets, a location of an asset from the plurality of assets in the landscape design, a genus of assets from the plurality of assets, a species of assets from the plurality of assets, a total amount of assets in the plurality of assets, data associated with the consumer inventory, recommendations based on the consumer inventory, recommendations based on the landscape design, recommendations based on a location of an asset from the plurality of assets in the landscape design, or a troubleshooting guide based on the consumer inventory.

38. The method of claim 33, wherein an asset from the plurality of assets is a plant-related product.

39. The method of claim 33, wherein the identifying and establishing are performed by the provider.

40. (canceled)

41. The method of claim 33, wherein the identifying includes uploading into the provider account module identifying information related to each asset from the plurality of assets.

42. The method of claim 33, wherein at least one of the provider account module or the consumer account is configured to receive sensor data from a sensor associated with an asset from the plurality of assets, the sensor data being associated with a status of the asset.

43. The method of claim 33, wherein the provider access module is configured to provide the provider access to a plant-related social network, the social network operative to virtually connect the provider with at least one of a plurality of other providers or a plurality of consumers including the consumer.

44. The method of claim 33, wherein the consumer account is configured to provide the consumer access to a plant-related social network, the social network operative to virtually connect the consumer with at least one of a plurality of providers including the provider, or a plurality of other consumers.

45. (canceled)

46. The method of claim 33, wherein the database is configured to be populated with the data by at least one of downloading information from a website, receiving information from the consumer via the consumer account, receiving information from a plurality of other consumers, receiving information from the provider via the provider account module, or receiving information from a plurality of other providers.

47. The method of claim 33, wherein the provider account module is accessed via the network by the provider, the provider having previously subscribed to the provider account module.

48. A method, comprising:
designing for a consumer a landscape including a plurality of assets;
inputting data associated with the plurality of assets into a provider account module, a unique code being generated for each asset from the plurality of assets based on the input data; and
providing the consumer with the unique codes generated for each asset from the plurality of assets, the consumer being provided access to a consumer account based on the unique codes, the consumer account configured to provide the consumer with information related to at least one of the landscape design or the plurality of assets.

49. The method of claim 48, wherein the input data includes at least one of the landscape design, a location of an asset from the plurality of assets in the landscape design, a type of an asset from the plurality of assets, a total amount of assets in the plurality of assets, or a total amount of each type of asset in the plurality of assets.

50-53. (canceled)

54. The method of claim 48, wherein the information includes at least one of the input data, a virtual representation of the landscape design, a provider of each asset from the plurality of assets, an inventory of the plurality of assets, recommendations based on the inventory, recommendations based on the landscape design, recommendations based on a location of an asset in the landscape design, or a troubleshooting guide based on the inventory.

55. The method of claim 48, wherein each asset from the plurality of assets is a plant-related product.

56. The method of claim 48, wherein the designing, the inputting, and the providing are performed by a landscape designer.

57. The method of claim 48, wherein the provider account module is configured to provide information related to at least one of a provider of each asset from the plurality of assets or a designer of the landscape.

58. The method of claim 48, wherein at least one of the provider account module or the consumer account is configured to receive sensor data from a sensor associated with an asset from the plurality of assets, the sensor data being associated with a status of the asset.

59. The method of claim 48, wherein the provider account module is configured to provide a landscape designer access to a plant-related social network, the social network operative to virtually connect the landscape designer with at least one of a plurality of asset providers, a plurality of other landscape designers, or a plurality of consumers including the consumer.

60-76. (canceled)
